(19) United States
(12) Patent Application Publication
(10) Pub. No.: US 2019/0352182 A1
(43) Pub. Date: Nov. 21, 2019

(54) NANOFIBER SHEET DISPENSER

(71) Applicant: Lintec of America, Inc., Richardson, TX (US)

(72) Inventor: Marcio D. Lima, Richardson, TX (US)

(73) Assignee: Lintec of America, Inc., Richardson, TX (US)

(21) Appl. No.: 16/397,036

(22) Filed: Apr. 29, 2019

Related U.S. Application Data
(60) Provisional application No. 62/672,673, filed on May 17, 2018.

(51) Int. Cl. C01B 32/16

(52) U.S. Cl. CPC C01B 32/16

(57) ABSTRACT

A nanofiber sheet dispenser that houses a nanofiber forest from which a nanofiber sheet can be drawn is described. Using the nanofiber sheet dispenser, a nanofiber forest disposed on a substrate can be moved, transported, and/or shipped with a reduced risk of damage relative to transporting a nanofiber sheet. Techniques are also described for configuring the nanofiber sheet dispenser so that a nanofiber sheet can be conveniently drawn from the forest and, in some cases, drawn so as to form a nanofiber yarn that is continuous with both the nanofiber sheet and the nanofiber forest, the latter of which is within the nanofiber sheet dispenser.

### TECHNICAL FIELD

The present disclosure relates generally to nanofiber fabrication. Specifically, the present disclosure relates to a nanofiber sheet dispenser.

### BACKGROUND

Nanofiber forests, composed of both single wall and multiwalled nanotubes, can be drawn into nanofiber ribbons or sheets. In its pre-drawn state, the nanofiber forest comprises a layer (or several stacked layers) of nanofibers that are parallel to one another and perpendicular to a surface of a growth substrate. When drawn into a nanofiber sheet, the orientation of the nanofibers change from perpendicular to parallel relative to the surface of the growth substrate. The nanotubes in the drawn nanofiber sheet connect to one another in an end-to-end configuration to form a continuous sheet in which a longitudinal axis of the nanofibers is parallel to a plane of the sheet (i.e., parallel to both of the first and second major surfaces of the nanofiber sheet). The nanofiber sheet can be treated in any of a variety of ways, including spinning the nanofiber sheet into a nanofiber yarn.

### SUMMARY

Example 1 is a nanofiber sheet dispenser comprising: a housing defining an interior and also defining an opening in the housing; a substrate and a nanofiber forest on the substrate, wherein the substrate and the nanofiber forest thereon are disposed within the interior of the housing; and at least one blade having an edged surface, the edged surface of the at least one blade defining a nanofiber sheet exit gap proximate to the opening in the housing.

Example 2 includes the subject matter of Example 1, wherein the at least one blade is connected to the housing.

Example 3 includes the subject matter of either Example 1 or Example 2, wherein the at least one blade comprises a first blade and a second blade, both of the first blade and the second blade connected to the housing and both a first edged surface and a second edged surface of the first blade and the second blade, respectively, confront one another to define the nanofiber sheet exit gap.

Example 4 includes the subject matter of any of the preceding Examples, wherein the at least one blade comprises a blade that includes a continuous edged surface around a perimeter of a nanofiber sheet exit gap.

Example 5 includes the subject matter of any of the preceding Examples, further comprising a nanofiber sheet integral with the nanofiber forest, a first portion of the nanofiber sheet disposed between the first edged surface and the second edged surface and in contact with at least one of the first edged surface and the second edged surface.

Example 6 includes the subject matter of any of the preceding Examples, wherein a second portion of the nanofiber sheet between the nanofiber forest and the nanofiber sheet exit gap forms an angle with respect to an interface between the substrate and the nanofiber forest of from 3° to 15°.

Example 7 includes the subject matter of any of the preceding Examples, further comprising a third portion of the nanofiber sheet on a side of the nanofiber sheet exit gap opposite that of the nanofiber forest, wherein the third portion forms an angle with respect to an interface between the substrate and the nanofiber forest of from 0° to 30°.

Example 8 includes the subject matter of any of the preceding Examples, further comprising a third blade having a third edged surface disposed in the interior of the housing between the opening defined by the housing and the substrate, the nanofiber sheet in contact with the third edged surface.

Example 9 includes the subject matter of Example 8, wherein: a fourth portion of the nanofiber sheet between the nanofiber forest and the third edged surface forms an angle with respect to an interface between the substrate and the nanofiber forest of from 2° to 15°; and a fifth portion of the nanofiber forest between the third edged surface and the nanofiber sheet exit gap, wherein the fifth portion forms an angle with respect to an interface between the substrate and the nanofiber forest of from 0° to 12°.

Example 10 includes the subject matter of Example 8, further comprising a fourth blade having a fourth edged surface disposed in the interior of the housing between the third blade and the nanofiber sheet exit gap, the nanofiber sheet in contact with the fourth edged surface.

Example 11 includes the subject matter of any of the preceding Examples, wherein one or more of the first blade, the second blade, the third blade, and the fourth blade have a corresponding arcuate edged surface.

Example 12 includes the subject matter of any of the preceding Examples, wherein one or more of the first blade, the second blade, the third blade, and the fourth blade comprises a fracture surface of a cleaved silicon wafer.

Example 13 includes the subject matter of any of the preceding Examples, wherein one or more of the first blade, the second blade, the third blade, and the fourth blade comprises a low surface energy coating.

Example 14 includes the subject matter of any of the preceding Examples, further comprising a nanofiber yarn spinner.

Example 15 includes the subject matter of Example 14, wherein a nanofiber yarn is continuous with the nanofiber sheet and the nanofiber forest.

Example 16 is a method comprising disposing a nanofiber forest on a substrate within an interior of a housing, the housing defining a nanofiber sheet exit gap that includes an edged surface; drawing a nanofiber sheet from the nanofiber forest through the nanofiber sheet exit gap and in contact with the edged surface; and responsive to the drawing in contact with the edged surface, densifying the nanofiber sheet.

Example 17 includes the subject matter of Example 16, wherein the edged surface forms a continuous edged surface around a perimeter of the nanofiber sheet exit gap.

Example 18 includes the subject matter of either of Examples 16 or 17, further comprising: disposing an additional blade having an additional edged surface within the interior of the housing between the nanofiber forest on the substrate and the nanofiber sheet exit gap; and drawing the nanofiber sheet in contact with the additional edged surface before drawing the nanofiber sheet through the nanofiber sheet exit gap.

Example 19 includes the subject matter of any of Examples 16 to 18, wherein an angle between a reference axis parallel to an interface between the nanofiber forest and the substrate and a portion of the nanofiber sheet between the nanofiber forest and the additional blade is from 2° to 15°.

Example 20 includes the subject matter of any of Examples 16 to 19, wherein drawing the nanofiber sheet through the nanofiber sheet exit gap comprises an angle of less than 45° relative to a reference axis parallel to an interface between the nanofiber forest and the substrate.

Example 21 includes the subject matter of any of Examples 16 to 20, wherein the edge surface is an arcuate edged surface.

### BRIEF DESCRIPTION OF THE DRAWINGS

FIG. 1 illustrates an example forest of nanofibers on a substrate, in an embodiment.

FIG. 2 is a schematic view of a furnace for the growth and synthesis of a nanofiber forest, in an example of the present disclosure.

FIG. 3 is an illustration of a nanofiber sheet that identifies relative dimensions of the sheet and schematically illustrates nanofibers within the sheet aligned end-to-end in a plane parallel to a surface of the sheet, in an embodiment.

FIG. 4 is an image of a nanofiber sheet being laterally drawn from a nanofiber forest, the nanofibers aligning from end-to-end as schematically shown in FIG. 2.

FIGS. 5A, 5B, and 5C illustrate various angles at which a nanofiber sheet can be drawn from a nanofiber forest on a substrate in the absence of geometric constraints, in embodiments.

FIG. 6A illustrates a cross-sectional side view of an example nanofiber sheet dispenser, in an embodiment.

FIG. 6B is an enlarged view of blades used to define a nanofiber sheet exit gap in the example nanofiber sheet dispenser illustrated in FIG. 6A, in an embodiment.

FIG. 6C is a transparent plan view of a nanofiber sheet being drawn from a nanofiber forest disposed within a nanofiber sheet dispenser, in an embodiment.

FIG. 6D is a transparent plan view of a nanofiber sheet being drawn from a nanofiber forest disposed within a nanofiber sheet dispenser and subsequently twisted into a nanofiber yarn, in an embodiment.

FIG. 6D′ illustrates a magnified image of a single-ply nanofiber yarn, in an embodiment.

FIGS. 6E-6K illustrate examples of arcuate edged surfaces and their corresponding effect on widths of nanofiber sheet drawn over and in contact with the arcuate edged surface, in embodiments.

FIG. 7A-7D illustrate various side views of a nanofiber sheet dispenser 600 being used to dispense a nanofiber sheet, in embodiments.

FIG. 8 illustrates an embodiment of an example nanofiber sheet dispenser that includes blades within the interior of the nanofiber dispenser as well the blades that define the nanofiber sheet exit gap, in an embodiment.

FIG. 9 is a perspective view of a blade having a continuous edged surface around an entire perimeter of a nanofiber exit gap, in an embodiment

FIG. 10 is a flow diagram illustrating an example method for using a nanofiber forest dispenser to produce a nanofiber sheet, in an embodiment.

The figures depict various embodiments of the present disclosure for purposes of illustration only. Numerous variations, configurations, and other embodiments will be apparent from the following detailed discussion. Furthermore, as will be appreciated, the figures are not necessarily drawn to scale or intended to limit the described embodiments to the specific configurations shown. For instance, while some figures generally indicate straight lines, right angles, and smooth surfaces, an actual implementation of the disclosed techniques may have less than perfect straight lines and right angles, and some features may have surface topography or otherwise be non-smooth, given real-world limitations of fabrication processes. In short, the figures are provided merely to show example structures.

### DETAILED DESCRIPTION

### Overview

While nanofiber forests, nanofiber sheets, and nanofiber yarns have a great deal of technological promise, practical barriers remain to widespread integration of these materials into products. One such practical barrier is the physical and mechanical fragility of nanofiber sheets. Nanofiber sheets can wrinkle, tear, adhere to themselves or to other sheets, or otherwise become mechanically damaged. Because of the light weight of these materials, even low velocity air currents (such as those from an air handling system or the opening of a door in an office) can cause a nanofiber sheet to fold, thus adhering to itself and rendering portions of the nanofiber sheet unusable for many applications.

For some of these same reasons, transporting nanofiber sheets is similarly difficult. When transported, a nanofiber sheet is generally packed so as to be maintained in a configuration that prevents folding, tearing, or flexing. Given the physical shocks that can occur during shipment (e.g., rapid accelerations and decelerations from a container being moved), even carefully packed nanofiber sheets can become damaged during shipment.

Thus, in accordance with some embodiments of the present disclosure, techniques are described for a nanofiber sheet dispenser that houses a nanofiber forest from which a nanofiber sheet can be drawn. In this way, a nanofiber forest disposed on a substrate (such as a stainless steel growth substrate) can be moved, transported, and/or shipped with a reduced risk of damage relative to a transported nanofiber sheet. A nanofiber forest on a substrate is generally more mechanically stable and physically durable than a nanofiber sheet, thus reducing the danger of damage during movement or transit. Techniques are also described for configuring the nanofiber sheet dispenser so that a nanofiber sheet can be conveniently drawn from the forest and, in some cases, drawn so as to form a nanofiber yarn that is continuous with both the nanofiber sheet and the nanofiber forest, the latter of which is within the nanofiber sheet dispenser.

Prior to describing some of the embodiments of these techniques, a description of nanofiber forest fabrication and nanofiber sheets follows.

### Nanofiber Forests

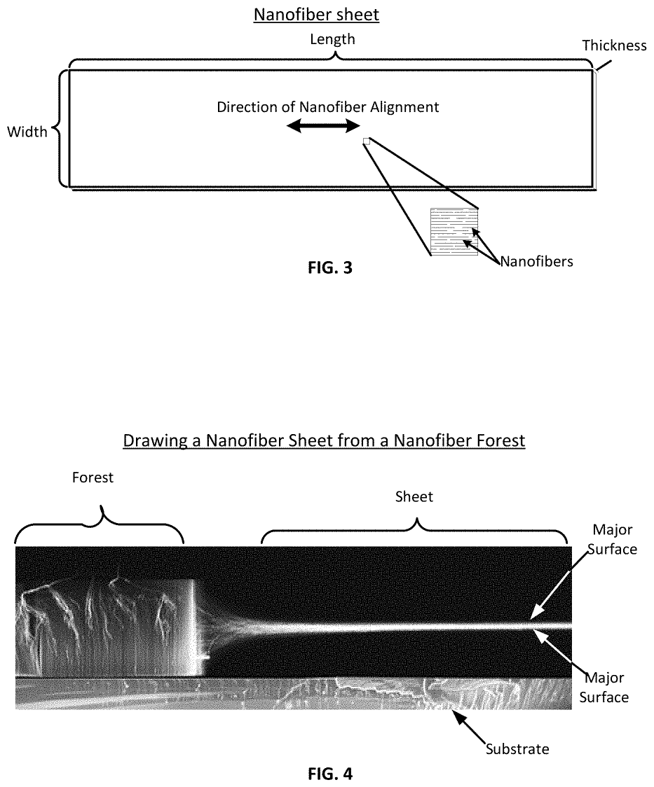

As used herein, the term “nanofiber” means a fiber having a diameter less than lμm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 3 and 4, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

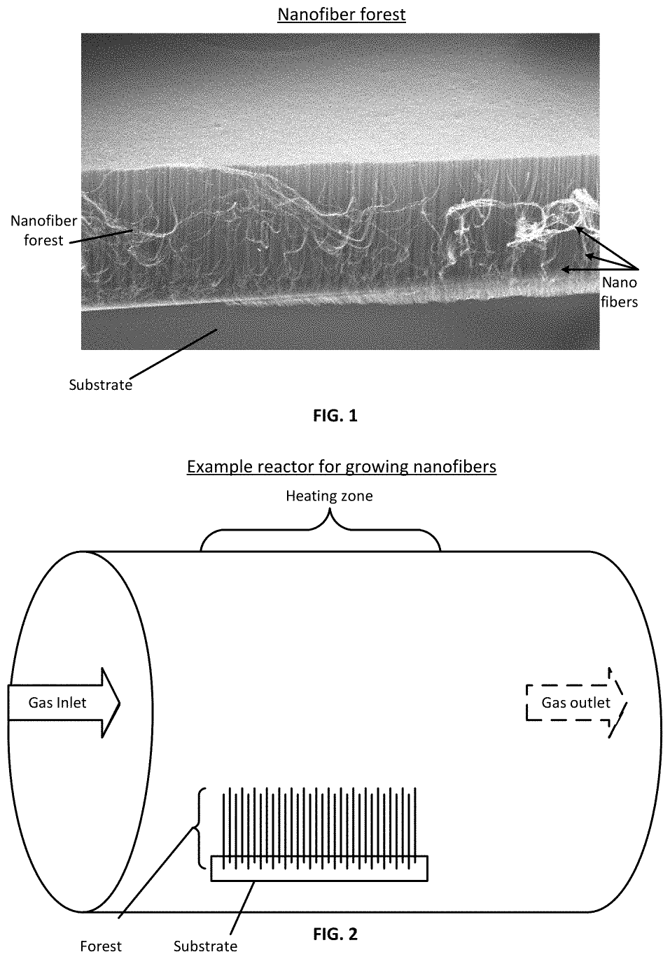

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 1 shows an example forest of nanofibers on a substrate. The substrate may be any shape but in some embodiments the substrate has a planar surface on which the forest is assembled. As can be seen in FIG. 1, the nanofibers in the forest may be approximately equal in height and/or diameter. In some cases, the forest may be “as deposited” meaning that the nanotubes were formed on the substrate, or in other cases may have been transferred from the growth substrate onto a secondary substrate.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, such as the one schematically illustrated in FIG. 2. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO2, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 3 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 3, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 4

As can be seen in FIG. 4, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Nanofiber Sheet Dispenser

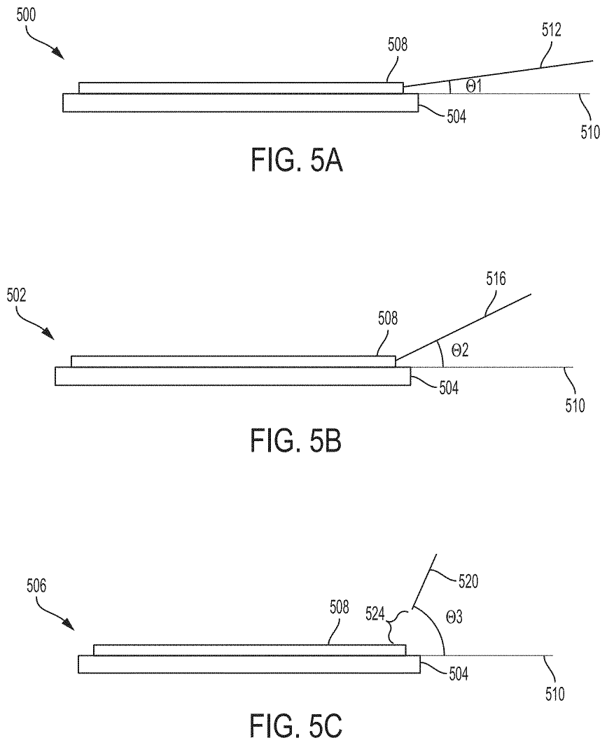

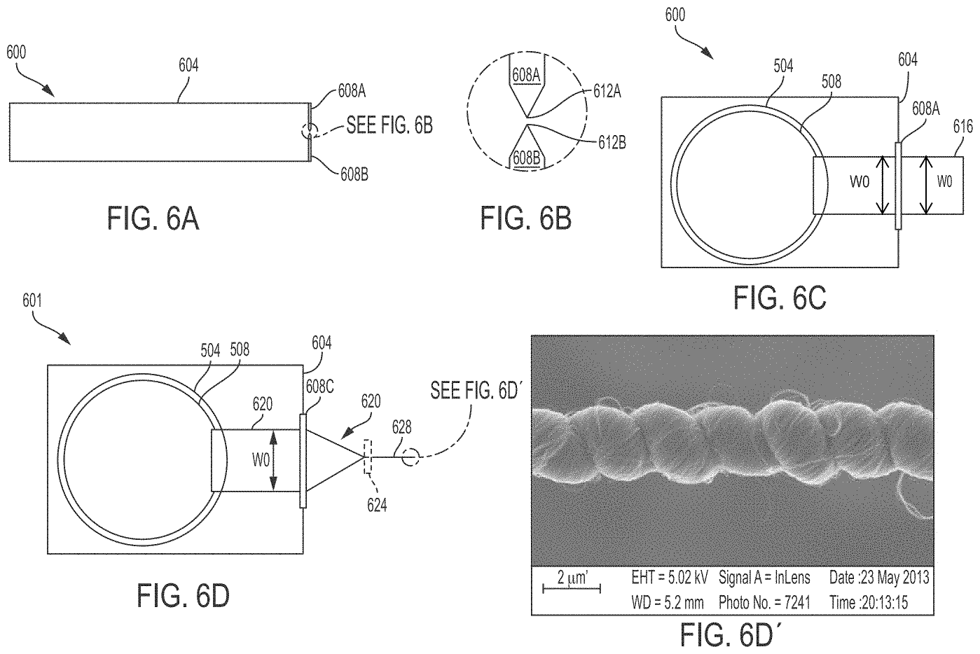

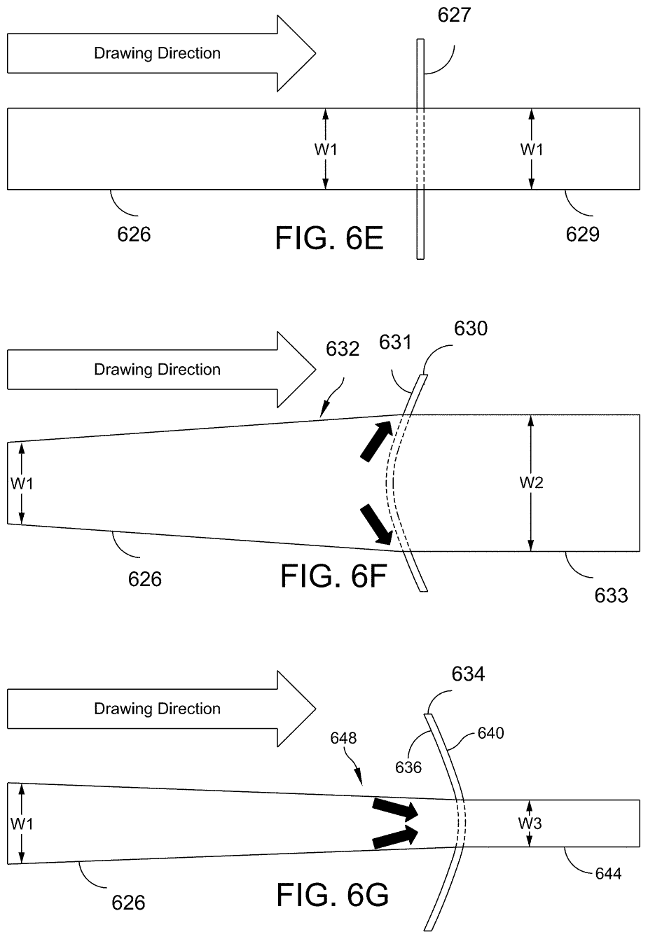

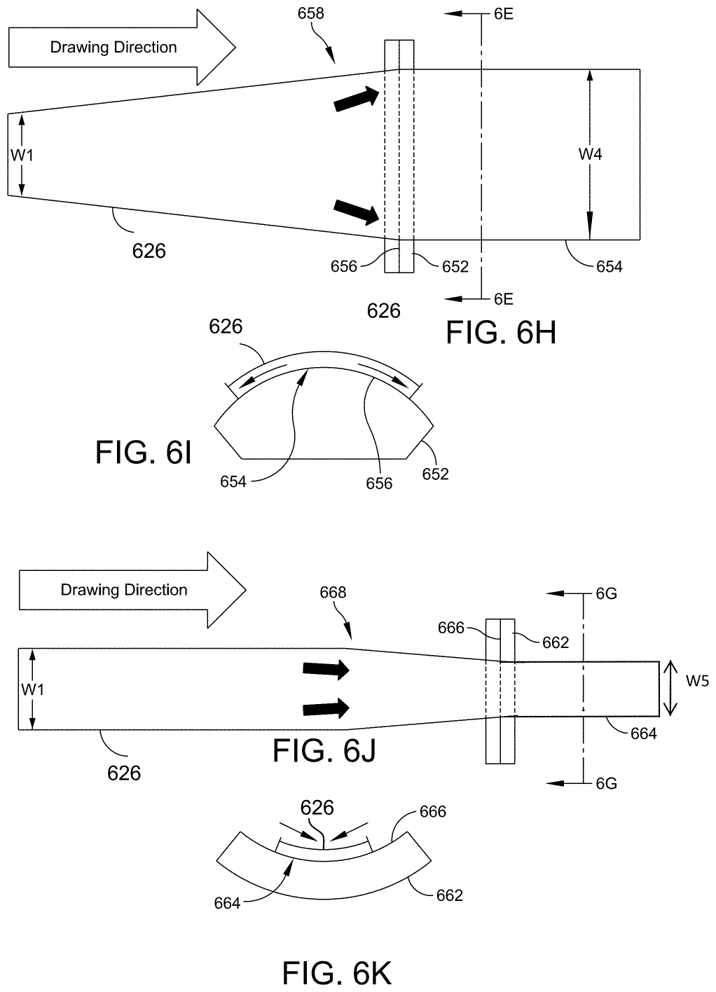

FIGS. 5A, 5B, and 5C illustrate various angles at which a nanofiber sheet can be drawn from a nanofiber forest on a substrate (whether a growth substrate or another substrate) in the absence of the beneficial geometric constraints provided by embodiments of the present disclosure, as explained below in more detail. FIGS. 5A, 5B, and 5C are presented to illustrate complications that can arise when drawing a nanofiber sheet from a nanofiber forest in the absence of mechanisms to control the angle at which the nanofiber sheet is drawn. These examples provide context for illustrating some of the advantages associated with embodiments described below in the context of FIGS. 6A to 8.

An arrangement 500 is schematically illustrated in FIG. 5A. The arrangement 500 includes a substrate 504, a nanofiber forest 508, and a nanofiber sheet 512. A reference axis 510 that is parallel to an interface between the substrate 504 and the nanofiber forest 508 is shown in FIG. 5A. As can be seen in FIG. 5A, the nanofiber sheet 512 is drawn from the nanofiber forest 508 (as described above) at an angle Θ1 measured relative to the reference axis 510. In some embodiments, the angle Θ1 can be within any of the following ranges: from 5° to 20°, from 5° to 10°, and from 5° to 15°.

An arrangement 502 is schematically illustrated in FIG. 5B. The arrangement 502 includes a substrate 504, a nanofiber forest 508, and a nanofiber sheet 516. The reference axis 510 is present in FIG. 5B for the same reasons explained above. As shown in FIG. 5B, the nanofiber sheet 516 is drawn from the nanofiber forest 508 at an angle □ □ □ that is greater than that of the angle Θ1 illustrated in FIG. 5A. In some embodiments, the angle □ □ □ can be within any of the following ranges: from 15° to 40°, from 15° to 30°; from 15° to 20°. This greater angle Θ2 at which the nanofiber sheet 516 is drawn in the arrangement 502 relative to the angle Θ2 shown in FIG. 5A is possible because of the lack of physical and/or geometric constraints around the nanofiber substrate 504 and nanofiber forest 508.

The difference in draw angles Θ1, Θ2 can produce differences in the physical, mechanical, thermal, and/or electrical properties of the corresponding nanofiber sheets 512, 516. For example, the nanofiber sheet 516 drawn at a higher angle may have nanofibers that are more aligned with one another, have a higher density, and a change in corresponding properties (e.g., a higher thermal and/or electrical conductivity) relative to the sheet 512 drawn at the angle Θ1 less than Θ2.

While the arrangements 500 and 502 produce nanofiber sheets 512, 516 that are continuous and connected to the corresponding nanofiber forests 508, the lack of geometric or physical constraints on the drawing angle increases the risk of a nanofiber sheet breaking during the drawing process. This is shown in the arrangement 506, as illustrated in FIG. 5C. The arrangement 506 includes a nanofiber substrate 504, a nanofiber forest 508, and the reference axis 510, all of which are described above. Unlike the preceding arrangements depicted in FIGS. 5A, 5B, the nanofiber sheet 520 in FIG. 5C is drawn from the nanofiber forest 508 at an angle Θ3. The angle Θ3, which is greater than the angle Θ2, is high enough so that the tensile strength of the nanofiber sheet 520 is exceeded, thus causing it to break from the nanofiber forest as indicated by gap 524. In some examples, the angle Θ3 can be greater than any of the following values: 40°; 45°; 50°.

As will be explained below, not only do some embodiments of the present disclosure provide a more durable mechanism for the transportation and movement of nanofibers materials, some may also provide for a nanofiber sheet that has a more consistent range of physical, electrical, mechanical, and/or thermal properties due to a more consistent draw angle. Greater predictability in various properties of a nanofiber sheet improves the ability and convenience with which nanofiber sheets are integrated into other products and/or technologies.

Turning now to FIG. 6A, a cross-sectional side view of an embodiment of a nanofiber sheet dispenser 600 is illustrated. The nanofiber sheet dispenser 600 includes a housing 604 and, in this example, blades 608A and 608B.

The housing 604 can be any shape although in this embodiment the housing 604 has an approximately rectangular cross-section. The housing 604 of the nanofiber sheet dispenser 600 defines an interior in which a substrate and a nanofiber forest thereon can be disposed. Neither the substrate or the nanofiber forest are shown in FIG. 6A for clarity of explanation, but are illustrated in other embodiments described below. The housing 604 also defines an opening, which in this case corresponds to some or all of one face of the rectangular cross-section nanofiber sheet dispenser 600. It will be appreciated in light of the following description that the opening defined by the housing 604 can be defined at any location by the housing 604. It will further be appreciated that the housing 604 is, in some embodiments, designed to be used at ambient temperatures. In other embodiments, the housing 604 can be designed to be inserted into a furnace (e.g., the housing is made of a material thermally stable at elevated temperatures, like stainless steel or aluminum) or other processing device.

The blades 608A and 608B (shown in enlarged view FIG. 6B), which can be connected to the housing 604, include corresponding edged surfaces 612A, 612B shown in cross-section. These edged surfaces 612A, 612B are arranged relative to the opening defined by the housing 604 so that a nanofiber sheet (not shown) passing through the opening also passes between, and in contact with, at least one of the edged surfaces 612A, 612B. Because the gap defined by the edged surfaces 612A, 612B is fixed relative to the substrate and nanofiber sheet thereon, the draw angle of the nanofiber sheet is also fixed within a range of angles much narrower than the unrestricted draw angle illustrated in FIGS. 5A-5C. As indicated above, this increases consistency in the properties of the nanofiber sheet because the draw angle is less variable than in an arrangement without a geometric and/or physical constraint. The consistent draw angle also reduces the risk of the nanofiber sheet breaking during drawing.

When drawn, the nanofiber sheet generally should contact one of the edged surfaces 612 and not contact other portions of the blade(s) 608 away from the edged surfaces 612. The nanofiber sheet will be densified (and optionally can have its width increased or decreased, as described below) and its continuity maintained by contact with the edged surface 612 alone. Contact with other portions of the blade 608 are more likely to cause the nanofiber sheet to wrinkle or tear.

As will be explained in more detail below, an angle at which the nanofiber sheet is drawn between the edged surfaces 612A, 612B determines which of the edged surfaces 612A, 612B the nanofiber sheet will contact while being drawn. Contact between a nanofiber sheet and an edged surface can help align the individual nanofibers of the nanofiber sheet with one another, thus densifying the sheet without the use of a solvent. Furthermore, in some embodiments, the edged surface can be an arcuate edged surface, as described below in more detail. Depending on whether the arcuate edged surface is concave or convex, the nanofiber sheet with may also be adjusted wider or narrower relative to the width of the sheet prior to contact with the edged surface. These features are described below in more detail.

FIG. 6C illustrates a transparent plan view of a nanofiber sheet dispenser 600 that includes a nanofiber forest and nanofiber sheet disposed therein. In this embodiment, the nanofiber sheet dispenser 600 includes a substrate 504, a nanofiber forest 508, the housing 604, blades 608A, 608B, a nanofiber sheet 616. Concurrent reference to FIGS. 6A, 6B and 6C will facilitate explanation

As shown in FIG. 6C, the substrate 504 and the nanofiber forest 508 disposed thereon are both within an interior of the housing 604 of the dispenser 600. Embodiments of the substrate 504, the nanofiber forest 508, and the housing 604 are all described above and need no further explanation. The nanofiber sheet 616 is drawn from the forest 508 so as to pass through an opening defined within one side wall of the rectangular cross-section housing 604 and between blades 608A, 608B. Only the blade 608A is shown in this view because of the perspective illustrated. As shown, a width W1 of the nanofiber sheet 616 remains constant at various locations along the nanofiber sheet 616 including between the blades 608 and the forest 508 and also on a side of the blades 608 opposite that of the nanofiber forest 508 external to the housing 604.

In some examples, whether for the embodiment shown in FIG. 6C or any of the other embodiments described herein, the nanofiber sheet (in this example, nanofiber sheet 616), can be temporarily attached to the housing 604 in preparation for shipment and subsequent drawing by the recipient. For example, the portion of the nanofiber sheet 616 on an exterior of the housing 604 can be attached to the housing 604 using adhesive tape, glue, or another adhesive or connector. The adhesive tape can be detached from the housing 604 and additional length of the nanofiber sheet 616 drawn from the forest 508 as needed.

FIG. 6D illustrates a dispenser 601 that is similar to the dispenser 600, but that is configured to produce a nanofiber sheet 620 that narrows ultimately to a nanofiber yarn 628, an example of which is shown in scanning electron micrograph FIG. 6D′. Production of a narrower embodiment of nanofibers (whether a sheet, ribbon, strand, or yarn) is shown by a width W0 of the nanofiber sheet 620 decreasing from W0 to widths narrower than W0, even up to the nanofiber yarn 628 that can be less than 10 microns in diameter.

Elements of the dispenser 601 common to the dispenser 600 are explained above. The dispenser 601 can be used to produce the nanofiber sheet 620 and/or the nanofiber yarn 628 using one or both of two different embodiments. In one embodiment, the dispenser 601 includes blades 608C and 608D that have an arcuate edged surface, and more specifically concave arcuate edged surfaces. Furthermore, examples of different types of arcuate edged surfaces and the corresponding effect on nanofiber sheet width and/or density are described in U.S. Provisional Appl. No. 62/542,355, which is incorporated herein by reference in its entirety.

Some examples of arcuate edged surfaces and their applications are described in the context of FIGS. 6E to 6K.

A direction in which the nanofiber sheet is drawn is indicated in each of the FIGS. 6E-6K by a labeled arrow. FIGS. 6E, 6F, and 6G illustrate embodiments in which a vector orthogonal to the arcuate surface of the edged surface is parallel (or antiparallel) to the drawing direction of the nanofiber sheet. FIGS. 6H, 6I, 6J, and 6K illustrate embodiments in which the radius of the arcuate surface is perpendicular to the drawing direction of the nanofiber sheet and perpendicular to the axis of the aligned nanofibers.

FIG. 6E illustrates an example in which a straight-edged (i.e., not arcuate) surface is used to apply a force to the nanofibers of the nanofiber sheet. As shown, the section 626 of the nanofiber sheet that has yet to contact the edged surface 627 has a width W1 that is the same as the width of the section 629 that has been drawn over (i.e., in contact with) and drawn past the edged surface 627.

FIG. 6F illustrates an example in which an edged surface 630 used to apply a force to the nanofibers of the nanofiber sheet is arcuate and has a convex face 631 disposed toward the direction from which the nanofiber sheet 626 is being drawn. As shown, the nanofiber sheet section 626 in its as-drawn (or more generally, as-supplied) state has a width W1. As indicated in FIG. 6F, drawing the nanofiber sheet 626 over and in contact with the convex edged surface 631 causes the nanofiber sheet 626 to widen to a width W2 in the second section 633, where the width W2 is greater than the width W1. This second section 633 of the nanofiber sheet can be less dense than the section 626 of the nanofiber sheet in its as-supplied (or as-drawn) state. In some examples, this widening begins prior to the actual contact between the nanofiber sheet 626 and the convex surface 631. This is indicated in FIG. 6F as a transition section 632 that comprises a width that increases from W1 to W2. This transition section 632 (and others described below) can occur at a line of contact between the nanofiber sheet and the edged surface or proximate to the line of contact.

The result of mechanically changing the width of the nanofiber sheet from the width W1 at the as-supplied section 626 to the greater width W2 at the second section 633 has the effect of reducing the density of the second section to a density less than the density of the as-supplied section 626.

FIG. 6G illustrates a situation analogous to that depicted in FIG. 6F except that a concave face 636 of an edged surface 634 is disposed to face the direction from which the nanofiber sheet is drawn. Similar to the scenario depicted in FIG. 6F, the scenario depicted in FIG. 6G includes an as-supplied nanofiber sheet section 626 with a width W1. The width of the nanofiber sheet is reduced when drawn over the concave edged surface 634 oriented as shown in FIG. 6G (i.e., with the concave surface 636 disposed toward the drawing direction). This narrower section 644 of the nanofiber sheet has a width W3 that is less than the width W1. In this example, the reduction in width can begin prior to actual contact between the nanofiber sheet and the concave edged surface 636, as indicated by the transition section 648.

The result of mechanically changing the width of the nanofiber sheet from the width W1 at the as-supplied section 626 to the narrow width W3 at the section 644 has the effect of increasing the density of the third section to a density greater than the density of the as-supplied section 626.

In an embodiment, a nanofiber sheet drawn from a nanofiber forest (or other nanofiber sheet source) and processed according to embodiments described herein can be thought of as having three sections. The first section (e.g., section 626) has a density corresponding to the nanofiber sheet as drawn from a nanofiber forest or as provided from a nanofiber sheet source (e.g., a spool of nanofiber sheet). This first section is disposed between the source of the nanofiber sheet (e.g., a forest, not shown) and the arcuate edged surface (e.g., arcuate edged surface 630, 634). The second section has a density different from the first section—whether a lower density (e.g., section 633) or a higher density (e.g., section 644). This second section is disposed between the arcuate edged surface and a drawing mechanism (not shown). Another section is disposed between these first and second sections and is a transition between the two (e.g., sections 628, 648). This transition section has an intermediate density that is between the density of the first section and the second section. In some embodiments, the density of this transition section decreases or increases uniformly between the first section and the second section.

FIGS. 6H to 6K illustrate an alternative configuration to those illustrated in FIGS. 6F to 6G, the former of which include an arcuate surface that is configured and arranged so that the radius of the arcuate surface is substantially perpendicular to the direction in which the nanofiber sheet is drawn. In related embodiments, the radius of the arcuate surface can be oriented, either into or away from the direction of draw, within any of the following ranges of angles: 0°-90°, 0°-80°, 0°-70°, 0°-60°, 20°-90°, 20°-70°, or 30°-90° from either the axis of draw or the axis of the aligned nanofibers, or both. FIG. 6H illustrates an embodiment in which an edge 656 of an arcuate surface 652 (such as a curved blade) is used to widen a width of the nanofiber sheet. Similar to the examples presented above, a nanofiber sheet section 626 in its as-drawn (or as-supplied) state has a width W1. The nanofiber sheet is drawn over and in contact with convex arcuate edge 656 of edged structure arcuate surface 652. The convex arcuate edge 656 causes the nanofiber sheet 626 to widen to a width W4 in the second section 654 of the nanofiber sheet, where the width W4 is greater than the width W1. As described above, the second section 654 can be less dense than the first section 626 of the nanofiber sheet in its as-supplied or as-drawn state. As also described in previous embodiments, in some examples the widening of the nanofiber sheet can begin prior to contact between the nanofiber sheet and the convex arcuate edge 656. This is indicated in FIG. 6H as transition zone 658 and by arrows on the nanofiber sheet within the transition zone 658. A cross-sectional view of FIG. 6H appears in FIG. 6I.

FIG. 6J illustrates an embodiment in which an edge 666 of a concave arcuate edge 662 is used to reduce a width of a nanofiber sheet from its as-drawn or as-supplied state. As above, the as-supplied nanofiber sheet section 626 has a width W1. This is drawn over and in contact with a convex edge 666 of a structure 662. While the entire structure 662 as shown in FIG. 6J is arcuate and concave, it will be appreciated that this is only one embodiment and that only the edge 666 need be convex and the structure 662 can be any shape (such as is shown in FIG. 6I for blade 652). Regardless, contact with the convex edge 666 causes the width W1 to be reduced to a width W5 that is less than the width W1 in a second section 664 of the nanofiber sheet. In examples, the second section 664 is denser than the as-supplied section 626. As with the previously described examples, the width reduction can occur in a transition section 668 that precedes contact between the edge 666 and the nanofiber sheet. This is indicated by arrows. A cross-sectional view of FIG. 6J appears in FIG. 6K.

In another embodiment, the dispenser 601 is disposed in series with an optional yarn spinning apparatus 624. The yarn spinning apparatus 624 can include embodiments such as a true twist spinner or a false twist spinner that applied twist to the free end or between ends of the nanofiber yarn, respectively. True twist and false twist spinners are described in PCT Application No. PCT/US2017/066665, which is incorporated by reference herein in its entirety. In one example, the yarn spinning apparatus 624 can include a rotating silicone rubber ring or band that is placed into contact with a strand of nanofibers drawn across the silicone rubber ring or band. This “false twist” spinner can provide a force that causes the nanofibers of a strand to draw closer to one another and become twisted together into a yarn.

In still yet another embodiment, the dispenser 601 includes both of the arcuate blades 608C and 608D and the optional yarn spinning apparatus 624.

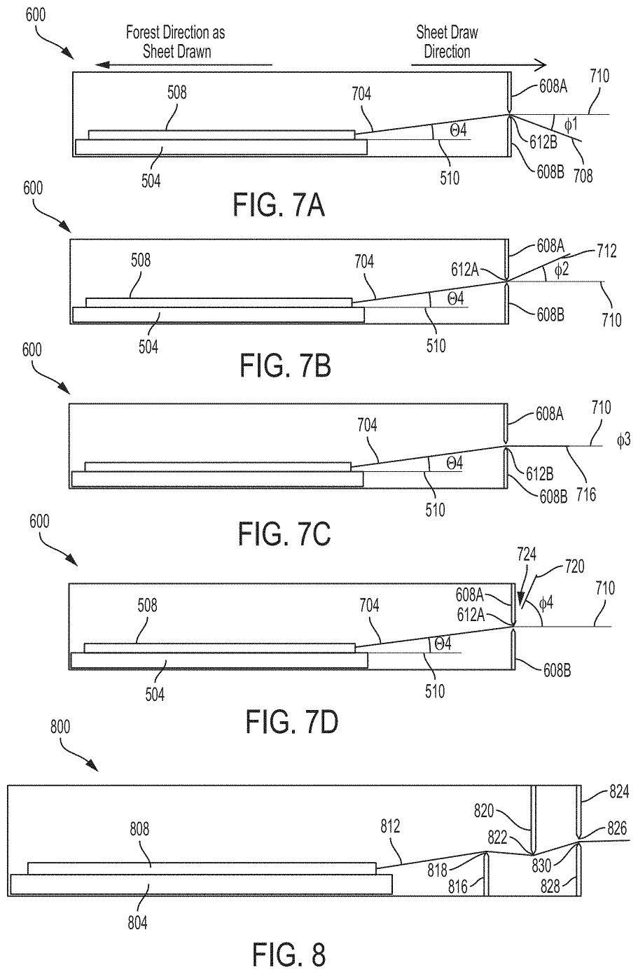

FIG. 7A through FIG. 7D illustrate various side views of a nanofiber sheet dispenser 600 being used to dispense a nanofiber sheet, in embodiments of the present disclosure. All of the embodiments shown in these figures include a housing 604, blades 608 with corresponding edged surfaces 612, as previously described. Reference axes 510 and 710 are parallel to the interface between the nanofiber forest 508 and the substrate 504 and are provided as a reference by which the angle at which a nanofiber sheet is drawn to the dispenser 600, Θ4, and the angle at which a nanofiber sheet can be drawn outside of the nanofiber dispenser 600, ϕ1, ϕ2, ϕ3, ϕ4 (respectively in FIGS. 7A-7D) are measured.

As shown in FIGS. 7A to 7D, for a given geometry (in other words, for configurations having a same (1) horizontal distance between a nanofiber forest/sheet interface (also termed the “leading edge” of the forest) and a surface of the housing defining the opening, and (2) a vertical distance between a nanofiber forest/sheet interface and the nanofiber sheet exit gap) the angle Θ4 remains approximately (+/−0.5°) constant regardless of the angle at which the nanofiber sheet is drawn once outside the nanofiber sheet dispenser 600. Some variation in an angle can occur depending on whether the nanofiber sheet is drawn to contact an edge of a blade on an upper surface of the exit gap (e.g., 612A of blade 608A) or an edge of a blade on a lower surface of the exit gap (e.g., 612B of blade 608B), and their corresponding heights relative to the nanofiber forest/sheet interface. As described above, this is because the angles and dimensions between the nanofiber forest and the nanofiber exit gap defined by the confronting edged surfaces 612 of the blades 608 determine the angle at which the nanofiber sheet is drawn within the dispenser 600 (in this case Θ4).

As also described above, this helps maintain consistency between nanofiber sheets because the draw angle, when performed at different angles, can change various properties of the nanofiber sheet. In some examples, the angle Θ4 can have a minimum value of as little as 3°, 4°, or 5°. In one example, the angle is about 10° (+/−5°). Greater angles will generally cause more densification of the nanofiber sheet during drawing. Generally, the values of the angle are positive because the plane of the nanofiber sheet 508 is below that of the plane that contains the nanofiber sheet exit gap defined by the edged surfaces 612. It will be appreciated that a minimum draw angle for a particular configuration can be calculated at an end of a forest furthest from the nanofiber opening: as more forest is drawn into a sheet, the leading edge of the nanofiber forest on the substrate 504 will recede in a direction opposite the direction in which the nanofiber sheet is drawn. These directions are indicated in FIG. 7A, and are applicable to other examples described herein.

In FIG. 7A, the angle ϕ1 has a magnitude within any of the following ranges and is measured “below” (or more generically, on a first side of) the reference axis 710: from 5° to 30°; from 2° to 30°; from 5° to 15°; from 15° to 30°; from 10° to 15°.

In FIG. 7B, the angle ϕ2 has a magnitude within any of the following ranges and is measured “above” (or more generically, on a second side opposite the first side of) the reference axis 710: from 5° to 30°; from 2° to 30°; from 5° to 15°; from 15° to 30°; from 10° to 15°.

In FIG. 7C, the angle ϕ3 can be above or below the reference axis 710 within any of the following ranges: 0° to 5°; 0° to 2°; 2° to 5°; 2° to 3°.

In FIG. 7D, the angle ϕ4 is sufficient to cause a nanofiber sheet 720 to break, as denoted by gap 724 defined by sheet portions 704 and 720. In this example, the angle can be greater than any of the following values (whether measured “above” or “below” the reference axis 710: 35°; 40°; 45°.

FIG. 8 illustrates an embodiment of a nanofiber sheet dispenser 800 that includes blades within the interior of the nanofiber dispenser 800 as well the blades that define the nanofiber sheet exit gap. In this example, the nanofiber sheet dispenser 800 includes a substrate 804, a nanofiber forest 808, a nanofiber sheet 812, blades 816, 820, 824, and 828.

Analogous to the examples described above the nanofiber sheet 812 is drawn from the nanofiber forest 808 so as to contact the edged surfaces 818, 822, and one of 830 and 826 of the corresponding blades. The blades within the interior of the dispenser 800 can further densify a nanofiber sheet or reduce the density by using an appropriately shaped edged surface as described above. Furthermore, the density and/or width of the nanofiber sheet 812 that can be obtained by using the dispenser 800 is either higher or lower that those achievable by the embodiments described above. This is in part due to the number of blades 816, 820, 824, 828 (or more in other embodiments) that apply force to the nanofiber sheet at multiple locations within the holder 800 and between the forest 808 and the blades 824, 828 at the nanofiber sheet exit gap. The angles of the various portions of the nanofiber sheet 812 between the forest 808 and the blade 816, between blades 816 and 820, and between blades 820 and 824/848 can be within any of the ranges described above that are low enough to avoid breaking the nanofiber sheet 812. In some examples, any of these angles can be between 2° and 30° measured relative to the forest 808/substrate 804 interface or a parallel reference axis.

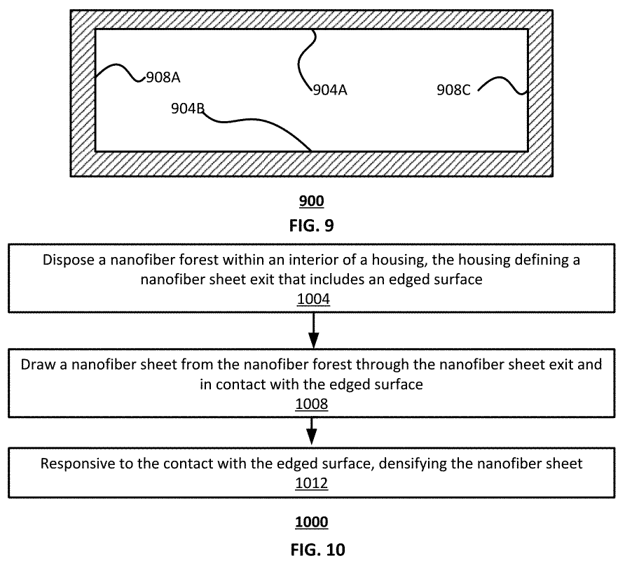

FIG. 9 illustrates an alternative configuration of a blade that can be used to prevent a nanofiber sheet from being damaged during drawing. In this perspective view, the blade 900 includes top and bottom edged surfaces 904A and 904B that are analogous to the blades described above. Furthermore, the blade 900 includes side edged surfaces 908A and 908B so as to form a continuous edged surface around an entire perimeter of a nanofiber exit gap of an attached nanofiber forest dispenser. These side edged surfaces 908A, 908B can have any of the configurations described above (e.g., a straight edged surface such as those shown in FIG. 6B, arcuate edged surfaces such as those described in FIGS. 6E to 6K). Regardless of the shape or profile the edged surfaces 908A, 908B, the presence of edged surfaces prevent the nanofiber sheet from being damaged, which would be more likely to happen when contacting a non-edged side of the nanofiber sheet exit gap of any of the holders described above.

Various other embodiments may include an electrical connection to one or more of the blades described above, the blades then acting as a resistive heater in response to the applied current. When heat is applied to a nanofiber sheet at an edged surface, in combination with the pressure applied to the sheet by the edged surface during drawing at an angle, the sheet can be further densified than when using pressure alone. Furthermore, in other embodiments the nanofiber forest can be supplied on a flexible substrate, such as stainless steel sheet, that is coiled within a nanofiber forest dispenser. In cooperation with an electrical motor and bearings, the nanofiber sheet can be drawn from the coiled nanofiber forest.

FIG. 10 is a method flow diagram of an example method 1000 for using a nanofiber forest dispenser of the present disclosure. In an embodiment, the method 1000 begins by disposing 1004 a nanofiber forest on a substrate within an interior of a housing, the housing defining a nanofiber sheet exit gap that includes an edged surface. The nanofiber sheet is then drawn 1008 from the nanofiber forest through the nanofiber sheet exit gap and in contact with the edged surface. Responsive to the drawing 1008 of the nanofiber sheet in contact with the edged surface, the nanofiber sheet is densified 1012.

### FURTHER CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A nanofiber sheet dispenser comprising:
a housing defining an interior and also defining an opening in the housing;
a substrate and a nanofiber forest on the substrate, wherein the substrate and the nanofiber forest thereon are disposed within the interior of the housing; and
at least one blade having an edged surface, the edged surface of the at least one blade defining a nanofiber sheet exit gap proximate to the opening in the housing.

2. The nanofiber sheet dispenser of claim 1, wherein the at least one blade is connected to the housing.

3. The nanofiber sheet dispenser of claim 1, wherein the at least one blade comprises a first blade and a second blade, both of the first blade and the second blade connected to the housing and both a first edged surface and a second edged surface of the first blade and the second blade, respectively, confront one another to define the nanofiber sheet exit gap.

4. The nanofiber sheet dispenser of claim 3, further comprising a nanofiber sheet integral with the nanofiber forest, a first portion of the nanofiber sheet disposed between the first edged surface and the second edged surface and in contact with at least one of the first edged surface and the second edged surface.

5. The nanofiber sheet dispenser of claim 4, wherein a second portion of the nanofiber sheet between the nanofiber forest and the nanofiber sheet exit gap forms an angle with respect to an interface between the substrate and the nanofiber forest of from 3° to 15°.

6. The nanofiber sheet dispenser of claim 1, wherein the at least one blade comprises a blade that includes a continuous edged surface around a perimeter of a nanofiber sheet exit gap.

7. The nanofiber sheet dispenser of claim 6, further comprising a third portion of the nanofiber sheet on a side of the nanofiber sheet exit gap opposite that of the nanofiber forest, wherein the third portion forms an angle with respect to an interface between the substrate and the nanofiber forest of from 0° to 30°.

8. The nanofiber sheet dispenser of claim 1, further comprising a third blade having a third edged surface disposed in the interior of the housing between the opening defined by the housing and the substrate, the nanofiber sheet in contact with the third edged surface.

9. The nanofiber sheet dispenser of claim 8, wherein:
a fourth portion of the nanofiber sheet between the nanofiber forest and the third edged surface forms an angle with respect to an interface between the substrate and the nanofiber forest of from 2° to 15°; and
a fifth portion of the nanofiber forest between the third edged surface and the nanofiber sheet exit gap, wherein the fifth portion forms an angle with respect to an interface between the substrate and the nanofiber forest of from 0° to 12°.

10. The nanofiber sheet dispenser of claim 8, further comprising a fourth blade having a fourth edged surface disposed in the interior of the housing between the third blade and the nanofiber sheet exit gap, the nanofiber sheet in contact with the fourth edged surface.

11. The nanofiber sheet dispenser of claim 10, wherein one or more of a first blade, a second blade, the third blade, and the fourth blade have a corresponding arcuate edged surface.

12. The nanofiber sheet dispenser of claim 10, wherein one or more of a first blade, a second blade, the third blade, and the fourth blade comprises a fracture surface of a cleaved silicon wafer.

13. The nanofiber sheet dispenser of claim 10, wherein one or more of a first blade, a second blade, the third blade, and the fourth blade comprises a low surface energy coating.

14. The nanofiber sheet dispenser of claim 1, further comprising a nanofiber yarn spinner.

15. The nanofiber sheet dispenser of claim 14, wherein a nanofiber yarn is continuous with the nanofiber sheet and the nanofiber forest.

16. A method comprising:
disposing a nanofiber forest on a substrate within an interior of a housing, the housing defining a nanofiber sheet exit gap that includes an edged surface;
drawing a nanofiber sheet from the nanofiber forest through the nanofiber sheet exit gap and in contact with the edged surface; and
responsive to the drawing in contact with the edged surface, densifying the nanofiber sheet.

17. The method of claim 16, wherein the edged surface forms a continuous edged surface around a perimeter of the nanofiber sheet exit gap.

18. The method of claim 16, further comprising:
disposing an additional blade having an additional edged surface within the interior of the housing between the nanofiber forest on the substrate and the nanofiber sheet exit gap; and
drawing the nanofiber sheet in contact with the additional edged surface before drawing the nanofiber sheet through the nanofiber sheet exit gap.

19. The method of claim 18, wherein an angle between a reference axis parallel to an interface between the nanofiber forest and the substrate and a portion of the nanofiber sheet between the nanofiber forest and the additional blade is from 2° to 15°.

20. The method of claim 16, wherein drawing the nanofiber sheet through the nanofiber sheet exit gap comprises an angle of less than 45° relative to a reference axis parallel to an interface between the nanofiber forest and the substrate.

21. The method of claim 16, wherein the edge surface is an arcuate edged surface.
